(19) United States
(12) Patent Application Publication
(10) Pub. No.: US 2004/0064786 A1
(43) Pub. Date: Apr. 1, 2004

(54) Appparatus and method for creating a workflow for printing and prepressing manufacturing

(75) Inventors: Iwata Ikeda, Kyoto (JP); Itaru Furukawa, Kyoto (JP); Setsuo Ohara, Kyoto (JP)

Correspondence Address: McDermott, Will & Emery, 600 13th Street, N.W., Washington, DC, 20005-3096, US

(73) Assignee: DAINIPPON SCREEN MFG. CO., LTD.

(21) Appl. No.: 10/668,282

(22) Filed: Sep. 24, 2003

(30) Foreign Application Priority Data
Sep. 26, 2002 (JP) P2002-280393
Jun. 16, 2003 (JP) P2003-170900

(51) Int. Cl. G06F 17/00

(52) U.S. Cl. 715/500

(57) ABSTRACT

A workflow creating apparatus stores rules (311) for creating workflows and environmental information (312) relating to execution of each process constituting the workflow in advance in an auxiliary storage. When output requirements (310) constituted by attribute values for an image recording media such as film, press plates, or printed matter etc. taken as finally resulting matter are designated by user operations, the processes required to make an image recording media satisfying the output requirements (310) are decided upon and the parameter values for each of the required processes are set by applying workflow creation rules (311) to each of the attribute values of the output requirements (310). A workflow is then created taking into consideration environmental information (312) based on results of applying these rules and tickets (321 to 323) corresponding to this workflow is created.

### BACKGROUND OF THE INVENTION

1. Field of the Invention

The present invention relates to an apparatus and method for generating a workflow for making image recording media such as film, press plates, or printed matter by providing page data described in page description language via rasterizing processing to an output unit (recorder) such as an image setter, plate setter, or digital printer etc.

2. Description of the Related Art

In the field of printing and prepressing manufacture, output data that is bitmap format image data is made from page data described using page description language such as PostScript (registered trademark of Adobe Systems USA) or PDF (Portable Document Format) etc. through rasterizing. This output data is then provided to an output unit (recorder) such as an image setter, plate recorder, or digital printer, etc. In this way, print content expressed by the page data is recorded as images on film, press plates, or paper stock etc. so as to obtain image recording media for printing or printed matter. In the operation of making image recording media from page data, a file, referred to as a “Job Ticket”, describing the required processing content is made, the necessary instructions are provided to equipment executing the processing required by the operation, and control of this equipment is carried out by the job ticket.

In the above operation in the field of printing and prepressing manufacture, it is necessary to specify processor modules corresponding to the required processes and their activation order, parameters provided to these processor modules, a host (processing apparatus such as a computer etc.) for executing these processor modules, and an output destination for the data created by these processor modules. It is therefore necessary to construct a workflow to perform the above operation. However, construction of a workflow is somewhat troublesome and improvements in efficiency on the related art have therefore been desired.

To this effect, a method of constructing a workflow utilizing a Graphical User Interface (GUI) on a computer has been proposed (refer to the specification of U.S. Pat. No. 6,380,951). This method makes the construction of a workflow more efficient as a result of using a computer and a GUI, but is not an automated method and as such does not completely resolve problems relating to the troublesomeness of workflow construction.

### SUMMARY OF THE INVENTION

In order to resolve the above problem, it is the object of the present invention to provide an apparatus and method for automatically generating a workflow in the field of printing and prepressing manufacturing.

In order to achieve the above object, the present invention has the characteristics shown below.

In a first aspect of the present invention, an apparatus for generating a workflow for making image recording media recorded with images expressed by page data from the page data described in page description language, comprises

a designator for designating attributes of the image recording media constituting finally resulting matter resulting due to processing based on the workflow to be created; and

a workflow creator for creating the workflow by deciding upon processes required in order to make the image recording media and parameter values for the required processes based on attributes designated by the designator.

According to this configuration, a workflow for making image recording media as finally resulting matter from page data can be automatically generated by just designating attributes of the image recording media. As a result, troublesomeness involved in the creation of a workflow can be dramatically reduced compared to the related art where the workflow construction process includes human intervention, and as a result the operation of the printing and prepressing manufacturing system is more efficient.

It is preferable for this apparatus to be further provided with a ticket creator for creating a job ticket indicating content of processes required to make the image recording media based on the workflow created by the workflow creator.

According to this configuration, a ticket is created corresponding to the workflow created by the workflow creator. Control to execute processing required to make the image recording media taken as the final resulting matter at apparatus such as the computer and the output unit (recorder) etc. in accordance with the workflow can then be carried out by utilizing the ticket. As a result, it is possible to reduce the number of errors at the time of execution due to operation errors with respect to these apparatus and it is possible for each apparatus to execute instructions without the user being aware of this complexity even for complex workflows such as multi-host constructed workflows.

The workflow creator of this apparatus preferably comprises

a rule storage unit for storing rules, corresponding to each attribute selectable for the image recording media, for creating the workflow for making the image recording media, in advance,

an environmental information storage unit for storing in advance environmental information indicating an environment for executing each process capable of being selected for making the image recording media, and

a process content decider for deciding upon processes required to make the image recording media and parameter values for the required processes based on attributes designated by the designator by referring to the rules and the environmental information.

This apparatus preferably comprises

a display having a prescribed screen,

a pointing device operated by a user for designating positions of the screen, and

a display controller for displaying a plurality of icons indicating the respective attributes selectable for the image recording media constituting the finally resulting matter at the display,

wherein the designator registers an attribute indicated by a selected icon as an output requirement when one of the plurality of icons is selected due to an operation of the pointing device,

the workflow creator creates a workflow based on attributes registered as output requirements, and

the display controller displays the created workflow at the display when the workflow creator creates a workflow.

According to this configuration, by using the Graphical User Interface (GUI) implemented by using the display, display controller, and pointing device, the attributes of the finally resulting matter (image recording media) are designated using processing based on the workflow to be created, and the created workflow is displayed at the display in real time. It is therefore possible to create the desired workflow with a straightforward operation.

In a further aspect of the present invention, a method for generating a workflow for making image recording media recorded with images expressed by page data from the page data described in page description language, comprises the steps of

designating attributes of the image recording media constituting finally resulting matter resulting due to processing based on the workflow to be created, and

creating the workflow by deciding upon processes required in order to make the image recording media and parameter values for the required processes based on designated attributes.

It is preferable for this method for generating a workflow to further comprise a step of creating a job ticket indicating content of processes required to make the image recording media based on the workflow created in the workflow creating step.

In this method for creating a workflow, the step of creating the workflow preferably comprises the steps of

reading rules, corresponding to each attribute selectable for the image recording media, for creating the workflow for making the image recording media,

reading environmental information indicating an environment for executing each process capable of being selected for making the image recording media, and

deciding upon processes required to make the image recording media and parameter values for the required processes based on the designated attributes by referring to the rules and the environmental information.

In a still further aspect of the present invention, a program for generating a workflow for making image recording media recorded with images expressed by page data from the page data described in page description language, the program, when executed by a computer, causing the computer to perform the steps of

designating attributes of the image recording media constituting finally resulting matter resulting due to processing based on the workflow to be created, and

creating the workflow by deciding upon processes required in order to make the image recording media and parameter values for the required processes based on designated attributes.

It is preferable for this program for creating a workflow to further comprise a step of creating a job ticket indicating content of processes required to make the image recording media based on the workflow created in the workflow creating step.

In this program for creating a workflow, the step of creating the workflow preferably comprises the steps of

reading rules, corresponding to each attribute selectable for the image recording media, for creating the workflow for making the image recording media,

reading environmental information indicating an environment for executing each process capable of being selected for making the image recording media, and

deciding upon processes required to make the image recording media and parameter values for the required processes based on the designated attributes by referring to the rules and the environmental information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a configuration for a digital printing and prepressing manufacturing system equipped with a workflow creating apparatus of a first embodiment of the present invention.

FIG. 2 is block diagram showing a hardware configuration for a workflow creating apparatus of the first embodiment.

FIG. 3 is an outline flowchart showing the operation of a workflow creating apparatus of the first embodiment.

FIG. 4 is a view showing a display screen (operation screen) constituting a GUI of the workflow creating apparatus of the first embodiment.

FIG. 5 is block diagram showing input/output data for workflow generation processing of the first embodiment.

FIG. 6 is a flowchart showing a procedure for processing for creating a workflow of the first embodiment.

FIG. 7 is a view showing an example of an attribute value taken as an output requirement provided for workflow creating in the first embodiment.

FIG. 8A to FIG. 8F are views showing results of workflow creation processing when the output requirement shown in FIG. 7 is provided in the first embodiment.

FIG. 9 is a view showing a further example of an attribute value taken as an output requirement provided for workflow creating in the first embodiment.

FIG. 10A and FIG. 10B are views showing results of workflow creation processing when the output requirement shown in FIG. 9 is provided in the first embodiment.

FIG. 11 is block diagram showing input/output data for workflow generation processing of a second embodiment of the present invention.

FIG. 12 is a view showing an example of an operation screen of the second embodiment.

FIG. 13 is a view illustrating imposition layout of the second embodiment.

FIG. 14 is a view showing an example of an attribute value taken as an output requirement provided for workflow creating in the second embodiment.

FIG. 15A to FIG. 15G are views showing results of workflow creation processing when the output requirement shown in FIG. 14 is provided in the second embodiment.

### DETAILED DESCRIPTION OF THE PREFERRED EMBODIMENTS

The following is a description with reference to the appended drawings of embodiments of the present invention.

First Embodiment

First, a description is given of a workflow creating apparatus of a first embodiment of the present invention.

1.1 Configuration of Printing and Prepressing Manufacturing System

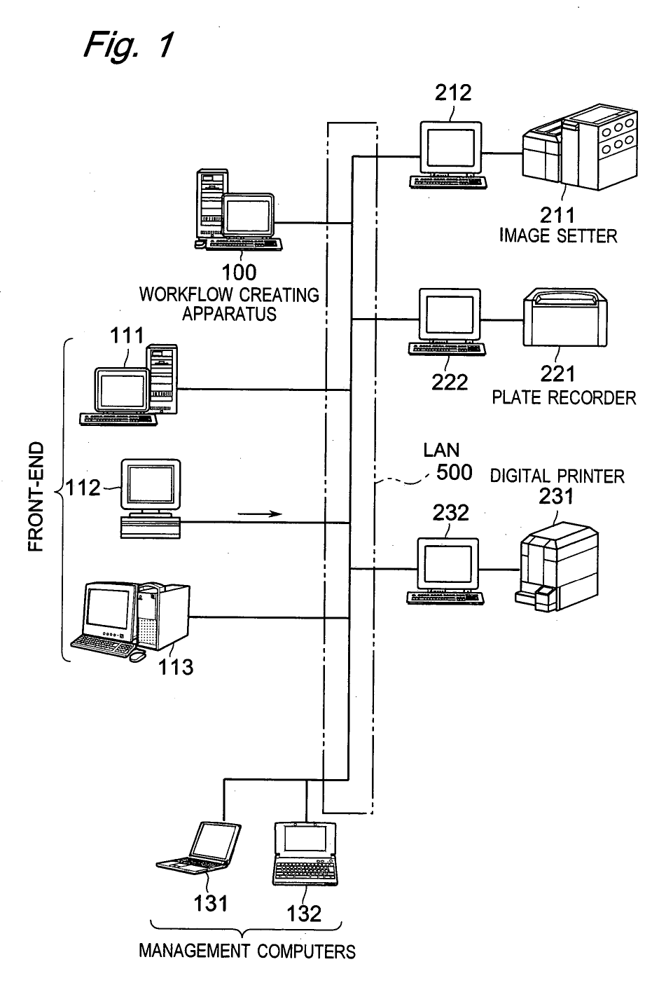

FIG. 1 is a view showing a configuration for a digital printing and prepressing manufacturing system equipped with a workflow creating apparatus of the first embodiment. This digital printing and prepressing manufacturing system comprises front-end computers 111 to 113 for editing and laying out a plurality of types of components such as characters, logos, designs and illustrations etc. for making printed matter, an image setter 211 and a computer 212 taken as a controller for the image setter 211, a plate recorder 221 and a computer 222 that is a controller for the plate recorder 221, a digital printer 231 and a computer 232 taken as a controller for the digital printer 231, and computers (hereafter referred to as management computers) 131 and 132 for managing progress and delivery of the operation from receipt of an order to printing. Each of the front-end computers 111 to 113 (hereafter collectively referred to simply as the “front-end”), the computers 212, 222 and 232 taken as controllers of the image setter 211, the plate recorder 221 and the digital printer 231, and each of the management computers 131 and 132 are connected so as to be capable of communication by a LAN (Local Area Network) 500 constituting a communication network. In addition, the digital printing and prepressing manufacturing system is provided with a workflow creating apparatus 100. The workflow creating apparatus 100 is also connected to the LAN 500 so as to be capable of communication with each of the front-end computers 111 to 113 and each of the controllers 212, 222 and 232. The number of front-end computers, image setters, plate decoders, digital printers and associated controllers included in this digital printing and prepressing manufacturing system is by no means limited to the number shown in FIG. 1.

In this digital printing and prepressing manufacturing system, page data describing the object to be printed using page description language are made by editing and laying out the components at the front-end. Any kind of image recording media such as film, press plates, or printed matter can be made from this page data and this operation is registered as a job based on the job ticket describing the processing content required by the operation. Namely, the workflow creating apparatus 100 creates a workflow for executing the operation based on user-designated attributes taken as attributes for the image recording media that is the final resulting matter from the operation and the creation results are saved as a job ticket. In this way, the operation is registered as a job and is input to a prescribed queue. When the turn of this job comes, page data is transferred to one of the controllers 212, 222 or 232 in accordance with the workflow corresponding to the content described in the corresponding job ticket (hereafter referred to simply as “ticket”). At the controller receiving this page data, bitmap data is made as output data from this page data via rasterizing processing etc. Then, at the image setter 211, plate recorder 221 or digital printer 231 connected to this controller, image recording media such as a film, printing plate, or printed matter etc. recorded with an image expressed by this output data is made as the final resulting matter.

1.2 Configuration of Workflow Creating Apparatus

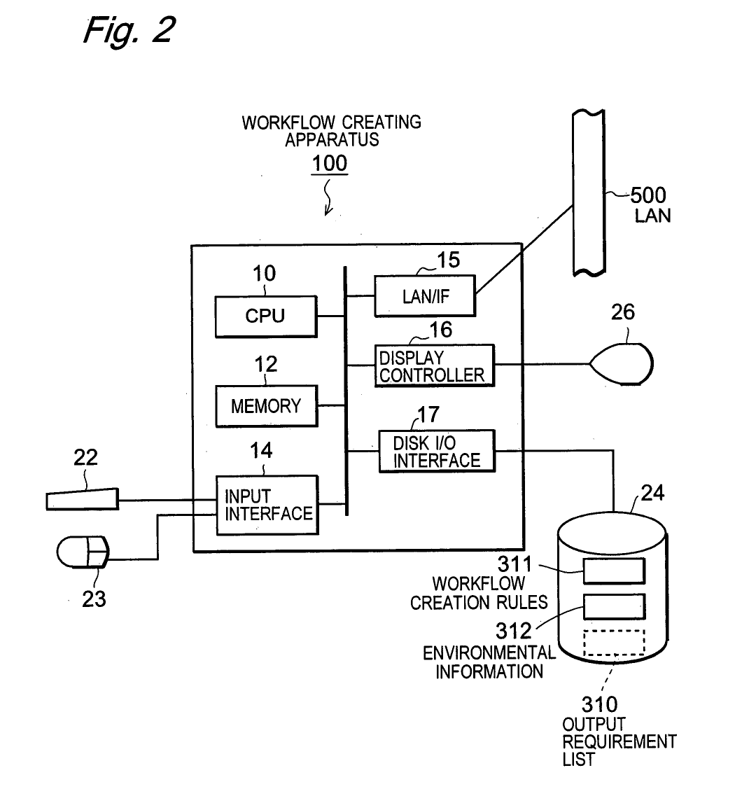

FIG. 2 is a block diagram showing a hardware configuration for a workflow creating apparatus 100 of this embodiment used in the above digital printing and prepressing manufacturing system. The workflow creating apparatus 100 is implemented using a personal computer and from a hardware point of view comprises a main unit of the personal computer, an input device of a keyboard 22 and mouse 23 etc., an auxiliary storage 24 utilizing a hard disk, and a display device 26 such as a liquid crystal display or CRT etc. The main unit of the personal computer comprises a CPU 10 that is a central processing unit, a memory 12 used for program storage and working area constructed of RAM and ROM etc., an input interface 14 to which the keyboard 22 and mouse 23 are connected, a LAN IF 15 for connecting the workflow creating apparatus 100 to the LAN 500, a display controller 16 to which the display device 26 is connected, and a disk I/O interface 17 to which the auxiliary storage 24 is connected. In the workflow creation process described later, workflow creation rules 311 that are rules for creating workflows according to information input based on user operations, and environmental information 312 that is information relating to the presence or absence of each of the various modules required to make the image recording media from the page data and to restrictions with respect to their execution, i.e. information indicating the environment for executing each process, are stored in the auxiliary storage 24 in advance. The details of the workflow creation rules 311 and the environmental information 312 are described below.

1.3 Overall Operation of Workflow Creating Apparatus

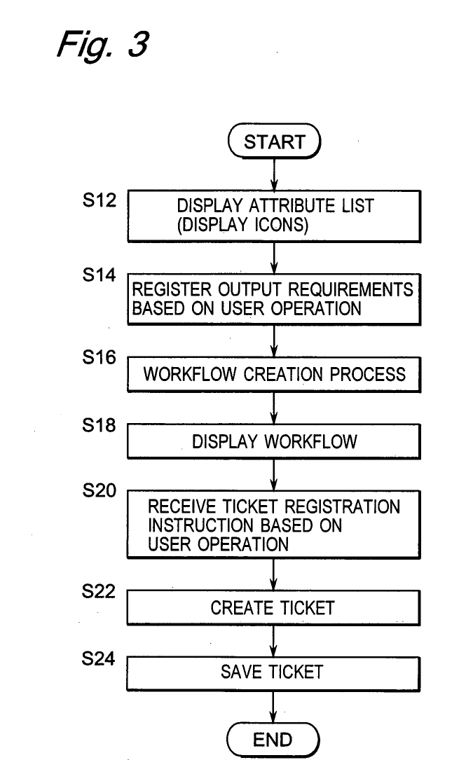

The workflow creating apparatus 100 operates in the manner shown in the flowchart of FIG. 3 as a result of a prescribed program loaded into the memory 12 from the auxiliary storage 24 being executed by the CPU 10 in order to create a workflow based on user operations. The following is a description with reference to FIG. 3 of the operation of the workflow creating apparatus 100.

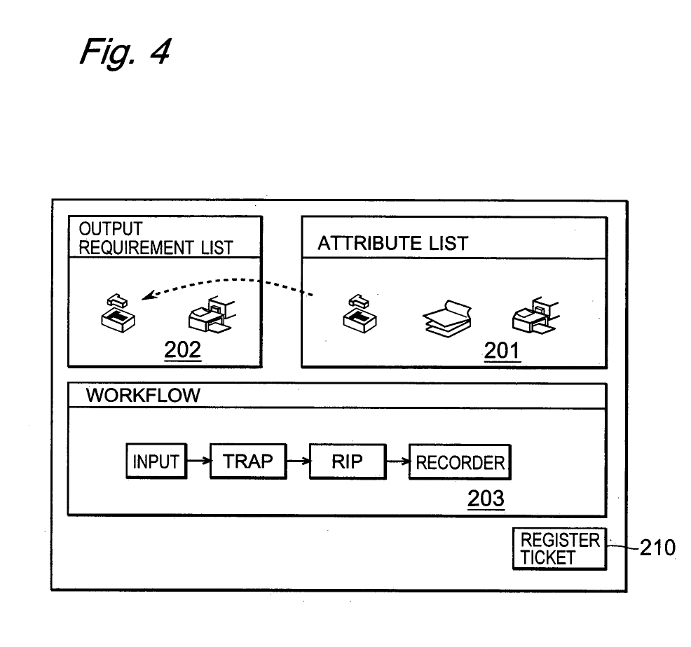

In the workflow creating apparatus 100 a Graphical User Interface (GUI) is implemented by using the display device 26, the display controller 16, a program (included in the prescribed program) executed by the CPU 10 in order to control the display device 26 via the display controller 16, and the mouse 23 constituting a pointing device. The workflow creating apparatus 100 displays the operation screen shown in FIG. 4 at the display device 26 as an operation screen for creation of a workflow as a result of the CPU 10 executing the prescribed program. The operation screen comprises an attribute list display area 201 for displaying each attribute selectable as an attribute for the image recording media (film, press plates, or printed matter etc. recorded with an image expressed by the page data made at the front-end) taken as the matter finally resulting from the digital printing and prepressing manufacturing system, an output requirement list display area 202 for displaying output requirements constituted by the attributes selected based on user operations as the attributes of the image recording media to be made by the user, and a workflow display area 203 for displaying the workflow generated. The display areas 201 to 203 are displayed in a mutually identifiable manner. Further, a ticket registration button 210 for instructing the creation of a ticket describing content of processing required to make the image recording media based on the created workflow is also displayed at the operation screen.

When the prescribed program for creating the workflow is activated, the workflow creating apparatus 100 displays icons indicating each of the attributes selectable as attributes of the image recording media to be made at the attribute list display area 201 of the operation screen shown in FIG. 4 (step S12). Here, an attribute is information for specifying the image recording media constituting the matter that is to result finally as a result of the workflow. These attributes may be the type (printed matter such as magazines, press plates, film etc.) of image recording media to be made as the finally resulting matter, number of items, size, variety of colors, presence or absence of a trap, and imposition method etc., with each icon indicating the selectable attribute values being displayed at the attribute list display area 201. At this time, the output requirement list display area 202 and the workflow display area 203 are blank.

In order to designate attributes of the image recording media to be made, the user selects icons indicating attributes of the image recording media to be made from the icons of the attribute list display area 201 displayed at the operation screen and drags and drops selected icons to the output requirement list display area 202 using the mouse 23. When this kind of operation is carried out by the user, the workflow creating apparatus 100 displays the selected icons in the output requirement list display area 202 and stores attribute values indicated by the icons displayed at the output requirement list display area 202 in a prescribed area of the memory 12 as elements of an output requirement list, so as to register the attributes as output requirements (step S14). After that, the output requirement list constituted by attribute values registered as output requirements is stored in the auxiliary storage 24 but may also be stored as is in the prescribed region of the memory 12. Rather than dragging and dropping an icon selected at the attribute list display area 201 by the mouse 23, the user may instead double-click, so that when this double-click operation is carried out, the workflow creating apparatus 100 displays the double-clicked icon in the output requirement list display area 202, so that the attribute value indicated by the icon displayed at the output requirement list display area 202 is registered as an output requirement. It is also preferable for a user to be able to designate attributes for the attribute values registered as output requirements in this manner in more detail. In this case, the following configuration, for example, may be adopted. Namely, in the case of specifying attributes in more detail with regards to an attribute value (a certain attribute value registered as the output requirement) indicated by a certain icon displayed at the output requirement list display area 202, the user double-clicks on the icon displayed in the output requirement list display area 202 using the mouse 23. When this operation is carried out, the workflow creating apparatus 100 separately displays an operation screen for more detailed setting for attributes for this attribute value indicated by the double-clicked icon, receives instructions regarding detailed content for the attribute value based on operation of the operation screen by the user, and registers this designated detailed content as output requirements.

When output requirements are registered in the aforementioned manner, the workflow creating apparatus 100 creates a workflow for making the image recording media satisfying the output conditions from the page data based on the attribute values included in the output requirements (step S16). The details of the workflow creation processing at this time are described later.

Next, the workflow creating apparatus 100 displays the workflow generated by the workflow creation process of step S16 at the workflow display area 203 at the operation screen of FIG. 4 (step S18). In the example shown in FIG. 4, the created workflow is shown to be configured from an input process, a trap process, an RIP operation process (rasterizing process), and a recorder output process (process of recording images on media such as film, press plates, or paper stock, etc.).

As described above, when the created workflow is displayed, the user confirms the creation of the workflow for making the image recording media with the designated attributes (output requirements) using this display and clicks the ticket registration button 210 of the operation screen of FIG. 4 using the mouse 23. When this operation is performed, the workflow creating apparatus 100 confirms receipt of an instruction indicating the creation of a ticket (step S20) and a ticket corresponding to the created workflow is created (step S22). Namely, a file describing the processing content such as the required processor modules, the computer intended to execute these modules, and parameter values corresponding to each processor module etc. required to make the image recording medium taken as the finally resulting matter is made as a ticket based on the created workflow using information taken as creation results of the workflow creation process of step S16. When it is wished to revise the workflow displayed at the display screen of FIG. 4 and is wished to change the output requirements, it is preferable to return to step S14 and recreate the workflow. In this case, it is possible to adopt a configuration where, for example, a cancel button is provided at the operation screen of FIG. 4 so that when this cancel button is operated using the mouse 23, step S14 is returned to and the steps thereafter are then re-executed.

When a ticket corresponding to the workflow created according to instructions given by the user for the attributes (output requirements) is created, the workflow creating apparatus 100 stores this ticket in the auxiliary storage 24 (step S24), and an operation for creating a workflow for a series of operations for making image recording media from the page data is complete. As already described above, when this ticket is saved, an operation corresponding to the processing content already described in this ticket is put in a queue as a single job. However, a configuration may also be possible in place of this where the created ticket is stored in a storage location decided in advance at the auxiliary storage 24 etc. When page data newly made at the front-end or notification to the effect that new page data has been made is sent from the front-end to the workflow creating apparatus 100, a ticket corresponding to this page data is issued from the workflow creating apparatus 100. The required processing may then be carried out at one of the controllers 212, 222 and 232 or at one of the image setter 211, plate recorder 221 or digital printer 231 in accordance with this ticket.

1.4 Workflow Creation Processing

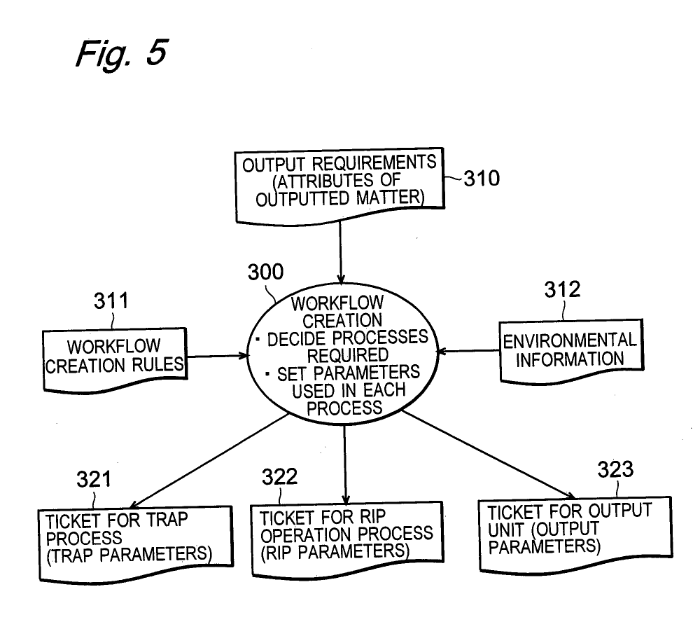

FIG. 5 is block diagram showing input/output data of a workflow creation process 300 (step S16) of this embodiment. In this embodiment, if attributes for the image recording media are taken as the finally resulting matter for the printing and prepressing manufacturing system then attention is paid to deciding upon processes necessary to make the image recording media from page data and the parameter values for this processing in a substantially unique manner. In a workflow creation process 300, a workflow is created based on output requirements 310 constituted by attribute values of matter (image recording media) finally resulting from an operation based on the workflow to be generated. Workflow creation rules 311 and environmental information 312 stored in advance in the auxiliary storage 24 are referred to when creating this workflow. Therefore, in addition to the output requirements 310 designated by the user, the workflow creation rules 311 and the environmental information 312 stored in advance in the auxiliary storage 24 also constitute input data of the workflow creation process 300.

Here, “workflow creation rules” are rules for constructing a workflow from attribute values selectable as attribute values of the image recording media constituting the finally resulting product and bring processes required to construct the workflow and parameter values for the processes into correspondence with the selectable attribute values. “Environmental information” is information (indicating the environment relating to each process executed) indicating the presence or absence of a module for each process, which computers each processor module is capable of being executed on, which of each processor module is capable of execution from the point of view of licensing, and which computer is to be used for execution when a plurality of computers that are capable of executing the same type of processor module exist, etc. For example, the following rules 1 to 4 are pre-stored in the auxiliary storage 24 as workflow creation rules.

(Rule 1): The following i) is executed when output (the media images are to be recorded to) is to paper.

i) Each module for input processing, RIP operation processing and printer processing is prepared.

(Rule 2): The following ii) to iv) are executed when size is designated as an output requirement.

ii) The designated size of paper is designated from the magazine as a printer processing parameter.

iii) Output size taken as an RIP operation process parameter is set as the size.

iv) An area for an image file comprised of bit map data obtained by the RIP operation processing is reserved in the auxiliary storage (hard disk).

(Rule 3): The following v) is executed when trap is set as an output requirement.

v) Insert a trap processor module.

(Rule 4): When a special color (color “orange” or bronze red” etc. other than the process colors (Y, M, C, K)) is set as an output requirement, the following vi) and vii) are executed.

vi) Take into consideration special colors in the RIP operation and trap processing.

vii) Specify the number of press plates taking into consideration the special colors.

Further, the workflow creation process 300 decides upon the processes (specifically, processor modules for executing these processes) required to make image recording media satisfying the output requirements (attribute values) designated by the user and sets parameter values for each process required. Namely, the workflow creation process 300 outputs data corresponding to tickets for each process including settings for parameter values for each required process. For example, as shown in FIG. 5, a trap processing ticket 321, RIP operation process ticket 322, and output unit (image setter, plate recorder, digital printer, etc.) ticket 323 constitute the output data of the workflow creation process 300.

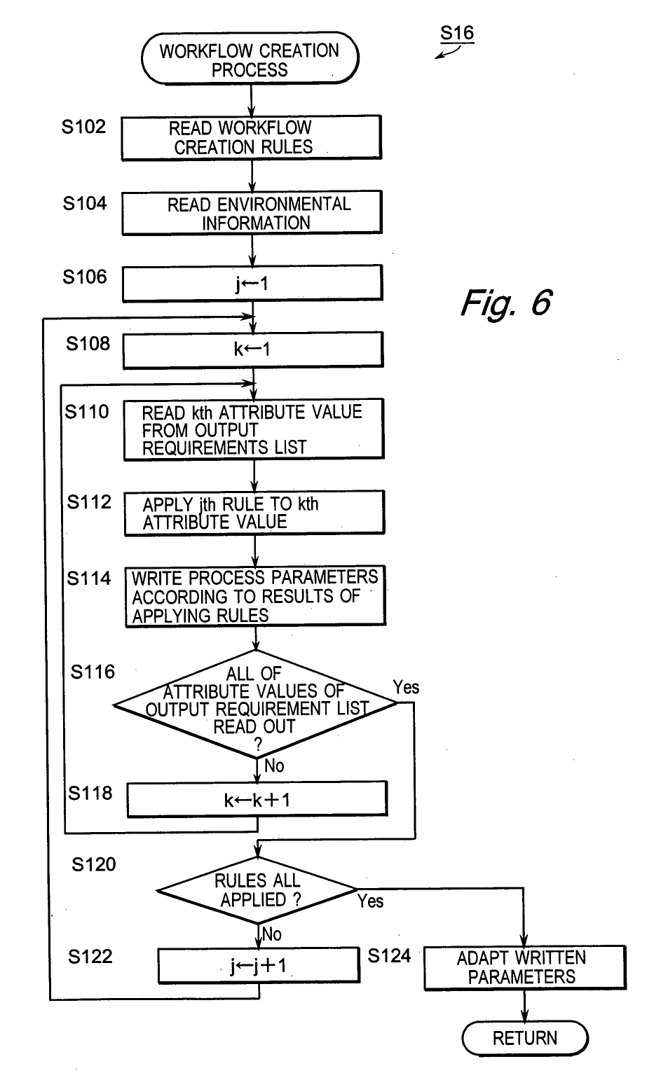

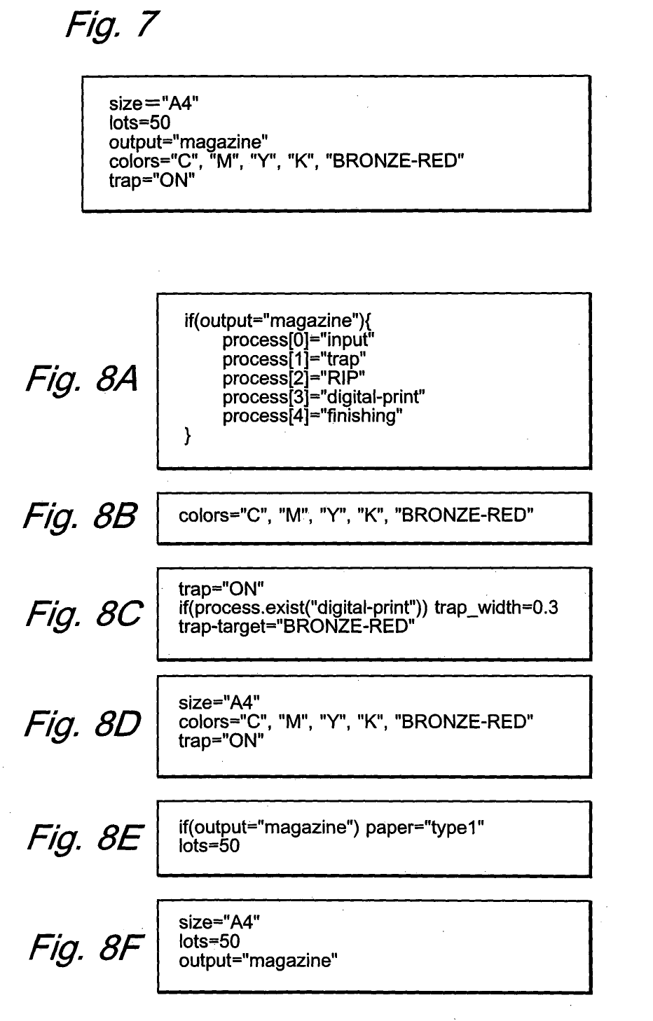

FIG. 6 is a flowchart showing the detailed procedure of the workflow creation process 300 (step S16). In the workflow creation process 300, the CPU 10 operates in the following manner.

The workflow creation rules 311 are read from the auxiliary storage 24 into the memory 12 (step S102). The environmental information 312 is then read from the auxiliary storage 24 to the memory 12 (step S104).

Next, a variable j for specifying each rule making up the workflow creation rules 311 is initialized to “1” (step S106). Then, an attribute value registered as the output requirement, i.e. a variable k specifying attribute values included in the output requirement list is initialized to “1” (step S108).

After this, a kth attribute value is read from the output requirement list within the auxiliary storage 24 to the memory 12 (step S110). For example, when the output requirement list is comprised of the attribute values shown in FIG. 7 (in the following, the description will proceed assuming the output requirement list of FIG. 7), when step S110 is first executed, then k=1, and the first attribute value of [size=“A4”] is read out. When the output requirement list is held in the memory 12, the CPU 10 is capable of directly accessing the output requirement list and step S110 is therefore not required.

The jth rule of the workflow creation rules 311 is then applied to the kth attribute value (step S112). For example, in the case where the workflow creation rules 311 are composed of the rules 1 to 4 (the following description proceeds under this assumption), the first time step S112 is executed, then j=1 and k=1, and rule 1 that is the first rule is applied to the first attribute value (size=“A4”). At this time, the first attribute value [size=“A4”] is not appropriate for the condition of rule 1 [output (media to be recorded with image) is paper]. It is therefore not possible to decide the processing required in the workflow creation, and information for workflow creation cannot be obtained.

After this, a process parameter is written according to the results of applying the rules in step S112 (step S114). When step S114 is first executed (j=1, k=1), the information for workflow creation cannot be obtained and the next step S116 is proceeded to without writing process parameters.

In the following step S116, a determination is made as to whether or not all of the attribute values included in the output requirement list have been read out. If the result of this determination is that attribute values as yet unread remain in the output requirement list, the variable k is incremented by one (step S118) and step S110 is returned to. Step S110 to step S118 are then repeatedly executed until all of the attribute values included in the output requirement list are read out. In this way, the jth rule is sequentially applied to the attribute values of the output requirement list and the process parameters are written to the memory 12 or the auxiliary storage 24 according the results of the application of this rule. Step S120 is then proceeded to when all of the attribute values included in the output requirement list are read out.

In step S120, a determination is made as to whether or not all of the rules comprising the workflow creation rules 311 have been applied. If the determination results are such that rules that have not-yet been applied still remain, the variable j is incremented by one (step S122) and step S108 is returned to. Steps S108 to S122 are then repeatedly executed until all of the rules comprising the workflow creation rules 311 have been applied. In this way, each of the rules comprising the workflow creation rules 311 is sequentially applied to each of the attribute values of the output requirement list and the process parameters are written to the memory 12 or the auxiliary storage 24 according the results of the application of this rule. Steps S124 is then proceeded to when all of the rules comprising the workflow creation rules 311 have been applied.

When step S124 is proceeded to, processor modules required in the workflow to be created are decided upon, and parameter values for each processor module are also decided upon and written. For example, by applying the aforementioned rule 1 to the third attribute value [output=“magazine”] of the output requirement list of FIG. 7, each of the modules for input processing, RIP operation processing, and printer processing are prepared (these processor modules are decided in advance in order of activation) as processor modules required by the workflow to be created. For example, by applying the aforementioned rule 2 to the first attribute value [size=“A4”] of the output requirement list of FIG. 7, A4-size paper is designated as a parameter of the printer process, A4-size is set as the output size at the time of operations as a parameter for the RIP operation process, and a storage area is reserved in the auxiliary storage 24 for the bitmap data obtained by the RIP operation process.

In step S124, parameter values written as parameter values for processor modules required to create the workflow are adapted so as to be appropriate for the ticket format (step S124). At this time, when none of the parameter values written out as parameter values for each of the required processor modules are compatible, default values are used for the parameter values that are not compatible. Further, at this time, environmental information relating to each of the required processor modules is extracted and is adapted to be appropriate for the ticket format for each processor module.

In this way, a workflow is generated based on specified output requirements by specifying processor modules required in the operation for making image recording media as the finally resulting matter fulfilling the registered output requirements from page data, the order of activation, parameters provided for these processor modules, processing apparatus such as computers etc. for executing the processor modules, and output destinations for the data generated by these processor modules. The workflow creation process is then complete. After this, the main routine shown in FIG. 3 is returned to, and the process from step S18 onwards (already described) is executed.

1.5 Specific Example of Workflow Creation Process

A description is given in the following of a specific example of the workflow creation process 300.

The attribute values of the output requirement list of FIG. 7 are shown in (a) to (c) below.

(a) Fifty lots of an A4-size magazine are to be made (first to third attribute values).

(b) Five-color printing of the four process colors and bronze-red (fourth attribute value).

(c) Trap present (fifth attribute value).

The creation results shown in FIG. 8A to FIG. 8F are obtained when a workflow for making the image recording media (in this case, printed matter) fulfilling the output requirements decided by the attribute values in the output requirements list is made by the workflow creation process 300 when assuming the workflow creation rules 311 comprised of the rules 1 to 4. FIG. 8A shows that an input process, trap process, RIP operation process, digital printing process and finishing process are required in order to make the image recording media (a magazine constituting printed matter) fulfilling the output requirements. FIG. 8B shows the parameter values for the input process, which in this case means the extraction of spot colors. FIG. 8C shows the parameter values of the trap process, which means that a trap is present, a trap width is set in line with the printer, and a trap is set for a special color. FIG. 8D shows parameter values for the RIP operation process, and shows that size is set, output presses are set, and trap execution is set. FIG. 8E shows the parameter values for the digital printing process, and indicates that the paper and the number of lots are selected. FIG. 8F shows the parameter values for the finishing process, and indicates the size and number of lots etc. for finishing.

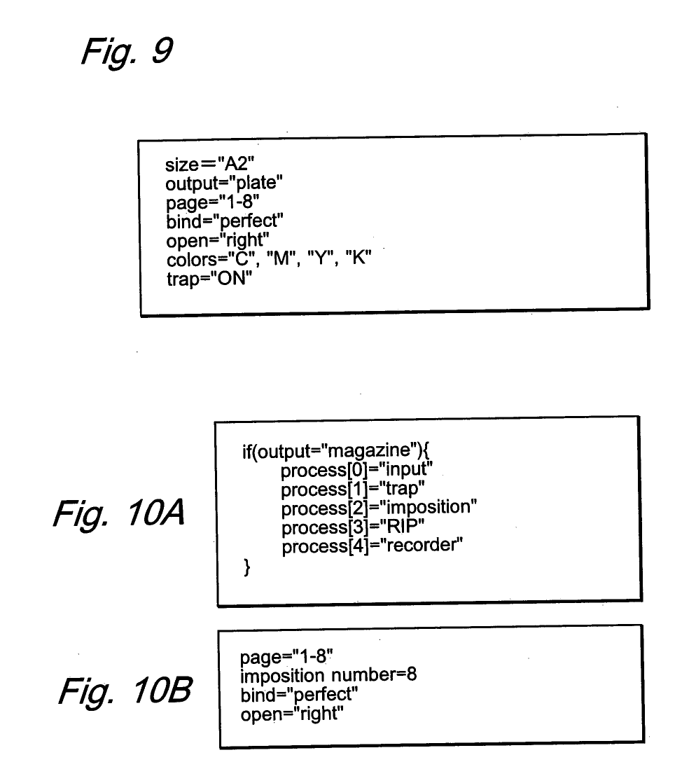

FIG. 9 shows a further example of an attribute value occurring in the output requirement list provided by the user when creating the workflow in this embodiment. The attribute values of the output requirement list are shown below in (d) to (g).

(d) Make A2-size printing press (first, second attribute value).

(e) Perform 8 pagination, perfect binding (saddle stitching), right-opening imposition process (third to fifth attribute values).

(f) Colors are only the four process colors (Y, M, C, K) (sixth attribute value).

(g) Trap present (seventh attribute value).

The creation results shown in FIG. 10A and FIG. 10B are obtained when a workflow for making the image recording media (in this case, printing presses) fulfilling the output requirements list is made by the workflow creation process 300 when assuming the workflow creation rules 311 comprising the rules 1 to 4. FIG. 10A shows that an input process, trap process, imposition process, RIP operation process, and recorded output process are required in order to make printing presses constituting the image recording media fulfilling the output requirements. FIG. 10B is a view showing parameter values for the imposition process, meaning performing 8 pagination, saddle stitching, and right-opening. Parameter values for processes other than the imposition process are also obtained as processing results of the workflow creation process 300. However, the correspondence of these parameter values and the output requirements is substantially the same as the case given for the output requirement list of FIG. 7 and the parameter values for these processes are therefore omitted in FIG. 10A and FIG. 10B.

1.6 Program Providing Styles

As described above, the functions of the workflow creating apparatus 100 are implemented based on a prescribed program executed by the CPU 10 assuming a computer as the hardware. Part or all of this program may, for example, be provided using a computer-readable recording media such as a CD-ROM recorded with the program. Namely, the user may purchase the CD-ROM taken as the recording media for the program, install the CD-ROM in a CD-ROM drive (not shown), read the program from this CD-ROM, and install the program in the auxiliary storage 24. Instead of this, it is also possible to receive the program which is sent via a communication network such as the LAN 500 or a WAN (Wide Area Network) etc., and install the program in the auxiliary storage 24. It is also possible for the manufacturer to install part or all of the program in the auxiliary storage 24 before shipping the workflow creating apparatus (or the digital printing and prepressing manufacturing system including the workflow creating apparatus 100). A description is given above of the styles for providing a prescribed program for implementing the functions of the workflow creating apparatus 100, and the same also applies for the second embodiment described below.

1.7 Advantageous Effects

According to the above embodiment, a workflow for making an image recording media (film, printing presses, printed matter, etc.) as a finally resulting product from page data in this printing and prepressing system is generated automatically with a user just designating the attributes of the image recording media. As a result, troublesomeness involved in the creation of a workflow can be dramatically reduced compared to the related art where the workflow construction process includes human intervention, and as a result, the operation of the printing and prepressing manufacturing system is more efficient. Further, a ticket is created corresponding to the workflow created by the workflow creating apparatus 100. Control to execute processing required to make the image recording media taken as the final resulting matter at apparatus such as the computer and the output unit (recorder) etc. in accordance with the workflow can then be carried out by utilizing the ticket. As a result, it is possible to reduce the number of errors at the time of execution due to operation errors with respect to these apparatus and it is possible for each apparatus to execute instructions even for complex workflows such as multi-host-constructed workflows without the user (operator) being aware of this complexity.

According to the above embodiment, attributes of finally resulting matter (image recording media) resulting from processing based on a workflow to be created are designated using a GUI realized using the display device 26, the display controller 16 and the mouse 23, and the generated workflow is displayed on the display device 26 (FIG. 4, step S14, S18), and the desired workflow can be created using a straightforward operation.

Second Embodiment

Next, a description is given of a workflow creating apparatus of a second embodiment of the present invention.

When the finally resulting matter of the digital printing and prepressing manufacturing system shown in FIG. 1 is a magazine or book having a large number of pages, a plurality of pages are usually printed on one piece of paper, with this paper being folded in order to bind a book. Because of this, it is necessary to decide the arrangement of the plurality of pages on this piece of paper in advance to ensure that the pages are in the appropriate order (up down, left to right). The arrangement of a plurality of pages on a single sheet of paper (i.e. the arrangement of printing presses for a plurality of pages to be printed at the same time) is referred to as “imposition”. Further, it is also necessary to decide the arrangement of accessories such as color patches and register marks taking into consideration the area for one page even in the case of printing just a single page on one sheet of paper. In the following, processing for carrying out deciding of the imposition and/or deciding of accessory layout is referred to as “imposition layout processing”. It is also possible for the processing for imposition to be understood to be included in RIP operation processing (in the case of the specific example shown in FIG. 9 for the first embodiment). However, the above imposition layout processing is considered to be essential processing not limited to the case of printing a plurality of pages on a single piece of paper and in this embodiment is handled as an independent process for configuring the workflow to be created.

The workflow creating apparatus of this embodiment (also taken to be shown using reference numeral 100), as with the first embodiment, is used in, for example, the digital printing and prepressing manufacturing system shown in FIG. 1 and the hardware configuration, overall operation, and workflow creation process are as shown in FIG. 2, FIG. 3, and FIG. 6 respectively and are the same as for the first embodiment. With regards to the GUI (Graphical User Interface), the configuration of the functions and the operation screen are the same as for the first embodiment. Parts of the hardware configuration and software configuration of this embodiment that are the same as for the first embodiment are given the same reference numerals and step numbers, and description thereof is omitted.

In this embodiment, the imposition layout process is handled as an independent process. The workflow creation rules, specific display content of the operation screen, and input/output data for the workflow creation process therefore differ from that of the first embodiment. The following is a description of this embodiment centering on these points of difference.

FIG. 11 is block diagram showing input/output data for workflow generation process 600 of this embodiment. In this embodiment, as with the first embodiment, in the workflow creation process 600, the workflow is created based on output requirements 610 constituted by attribute values for the finally resulting matter (image recording media) obtained by operations based on the workflow to be generated. Workflow creation rules 611 and environmental information 612 stored in advance in the auxiliary storage 24 are referred to, in the same way as for the first embodiment, when creating this workflow. Therefore, in addition to the output requirements 610 designated by the user, the workflow creation rules 611 and the environmental information 612 stored in the auxiliary storage 24 also constitute input data of the workflow creation process 600. With regards to the output requirements 610 and environmental information 612, there are no practical differences with the output requirements 310 and the environmental information 312 of the first embodiment but workflow creation rules 611 have parts that differ from the workflow creation rules 311 of the first embodiment. In this embodiment, for example, the following rules 11 to 14 are stored in advance in the auxiliary storage 24 as the workflow creation rules 611.

(Rule 11): The following i) is executed when output (the media images are to be recorded to) is to paper.

i) Each module for input processing, RIP operation processing and printer processing is prepared.

(Rule 12): The following ii) to v) are executed when size (page size and paper size) is designated as an output requirement.

ii) The designated size of paper is designated from magazine as a printer processing parameter.

iii) Output size taken as an RIP operation process parameter is set as the size.

iv) An area for an image file comprised of bit map data obtained by the RIP operation processing is reserved in the auxiliary storage (hard disk).

v) The module for the imposition layout process is inserted and the number of pages to be printed simultaneously and the position on the paper of the pages to be printed simultaneously are calculated based on the paper size and page size designated by the output requirements.

(Rule 13): The following vi) is executed when trap is set as an output requirement.

vi) Insert a trap processor module.

(Rule 14): When a special color (color other than the process colors (Y, M, C, K)) is set as an output requirement, the following vii) and viii) are executed. vii) Take into consideration special colors in the RIP operation and trap processing.

viii) Specify the number of press plates taking into consideration the special colors.

In addition to deciding upon the processes (specifically, processor modules for executing these processes) required to make image recording media satisfying the output requirements (attribute values) designated by the user, the workflow creation process 600 sets parameter values for each process required. Namely, as with the first embodiment, the workflow creation process 600 outputs data corresponding to tickets for each process including settings for parameter values for each required process. In this embodiment, since a processor module for imposition layout processing is prepared as an independent module, for example, as shown in FIG. 11, output data for the workflow creation process 600 is comprised of a trap process ticket 621, an imposition layout process ticket 622, an RIP operation process ticket 623, and an output unit (image setter, plate recorder or digital printer etc.) ticket 624.

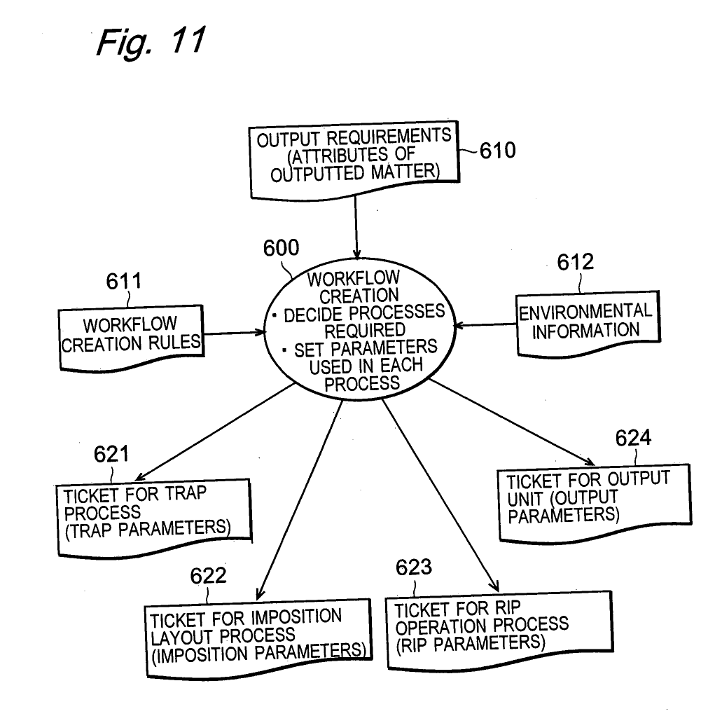

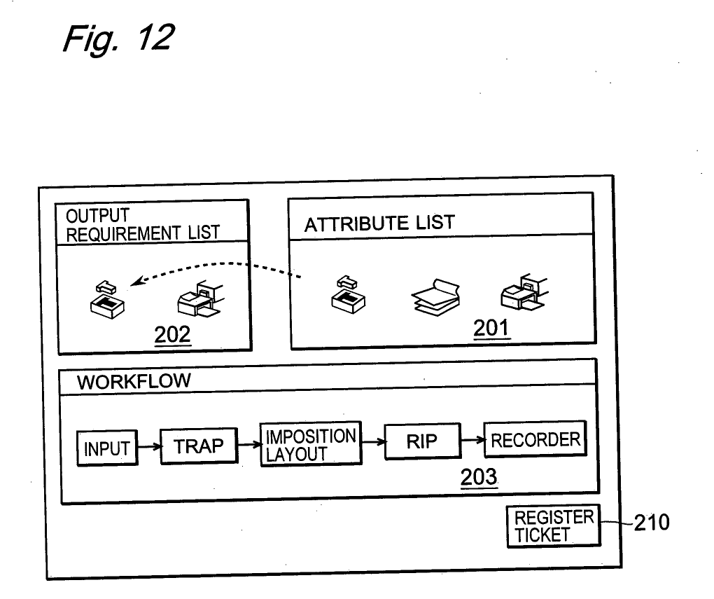

The function of the GUI in this embodiment is the same as for the first embodiment. However, because of preparing the module for the imposition layout process as described above, a workflow created by the workflow creation process 600 is displayed at the workflow display region 203 of the operation screen as shown, for example, in FIG. 12. In the example shown in FIG. 12, the created workflow is shown to be configured from an input process, a trap process, an imposition layout process, an RIP operation process (rasterizing process), and a recorder output process (process of recording images on media such as film, press plates, or paper stock, etc.).

The detailed procedure for the workflow creation process 600 (step S16 in FIG. 3) in this embodiment is the same as for the first embodiment as shown in FIG. 6, and a description thereof is omitted.

A description is given in the following of a specific example of the workflow creation process 600 of this embodiment.

FIG. 14 shows as an example of the output requirement 610 an output requirement list that is a list of attribute values for the image recording media that is the finally resulting matter. The attribute values of the output requirement list are shown below in (h) to (k).

(h) Fifty lots of an A4-size magazine are to be made (first to third attribute values).

(i) The paper size is 490×624 (fourth attribute value).

(j) Five-color printing of the four process colors and bronze-red (fifth attribute value).

(k) Trap present (sixth attribute value).

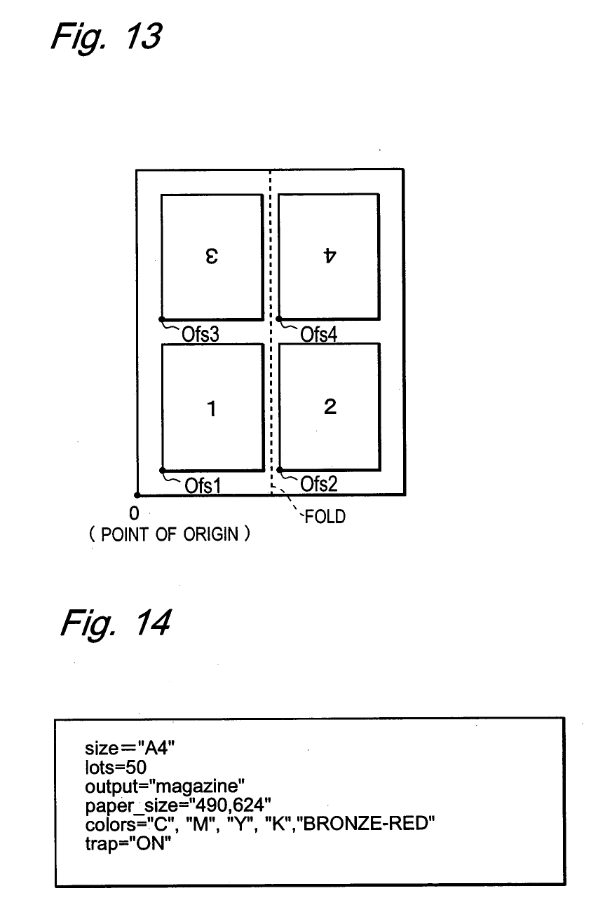

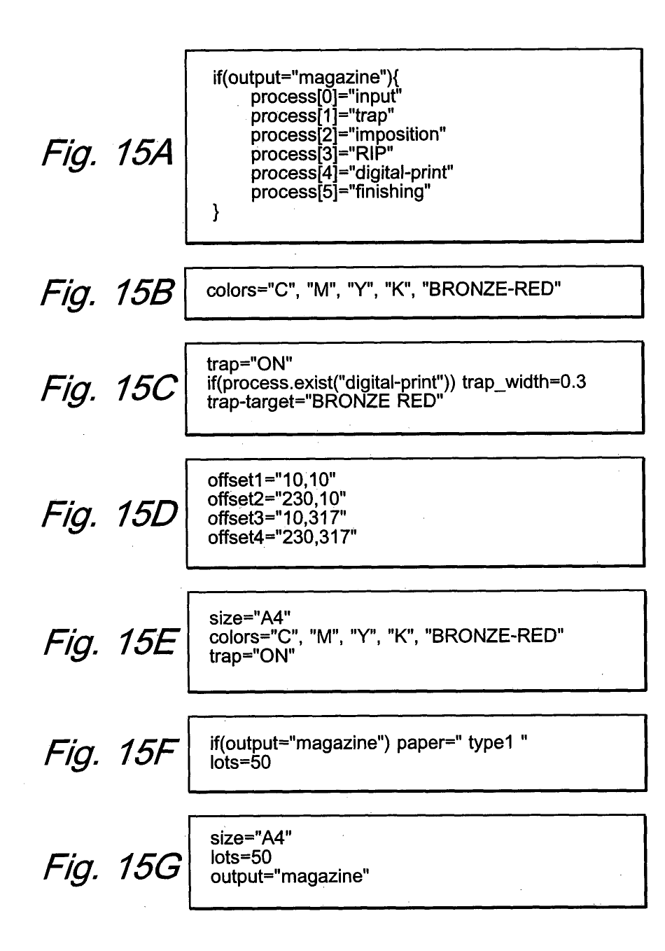

The creation results shown in FIG. 15A to FIG. 15G are obtained when a workflow for making the image recording media (in this case, a magazine constituting printed matter) fulfilling the output requirements decided by the attribute values is made by the workflow creation process 600 (refer to FIG. 6) when assuming the workflow creation rules 611 comprised of the rules 11 to 14. FIG. 15A shows that an input process, trap process, RIP operation process, imposition layout process, digital printing process and finishing process are required in order to make an image recording media (a magazine) fulfilling the output requirements from pagedata. FIG. 15B shows the parameter values for the input process, which in this case means the extraction of spot colors. FIG. 15C shows the parameter values of the trap process, which means that a trap is present, a trap width is set in line with the printer, and a trap is set for a special color. FIG. 15D shows parameter values for the imposition layout process calculated by applying v) of rule 12 to (h) and (i) described above and shows the layout position for each page when four pages are fitted on a single piece of paper as shown in FIG. 13. Namely, Ofs1 to Ofs4 show the left edge lower end of each page in the case of taking the left edge lower end of this piece of paper as a point of origin. FIG. 15E shows parameter values for the RIP operation process, and shows that size is set, output presses are set, and trap execution is set. FIG. 15F shows the parameter values for the digital printing process, and indicates that the paper and the number of lots are selected. FIG. 15G shows the parameter values for the finishing process, and indicates the size and number of lots etc. for finishing.

According to this above embodiment, as with the first embodiment, a workflow for making an image recording media (film, printing presses, printed matter, etc.) as a finally resulting product from page data in this printing and prepressing manufacturing system is generated automatically with a user just designating the attributes of the image recording media. As a result, troublesomeness involved in the creation of the workflow can be dramatically reduced compared to the related art where the workflow construction process includes human intervention, and as a result the operation of the printing and prepressing manufacturing system is more efficient, so that the same advantageous effects as for the first embodiment are obtained. In this embodiment, when the imposition layout process is built-into the created workflow, parameters required in the processing for imposition in accordance with the attribute values designated by the output requirements are created automatically.

In the above specific example (refer to FIG. 14), the number of pages printed simultaneously and the positions of each page (Ofs1 to Ofs4) printed simultaneously are automatically calculated from the page size (A4) and the paper size (490×624) designated as output requirements. However, at this time, as shown in FIG. 13, it is assumed that each page is positioned towards the center of the paper in a direction from left to right. It is also possible to arrange the pages evenly on the paper instead. Moreover, it is also possible to include a method for calculating coordinates indicating the position of arrangement of each page in the workflow creation rule 611 instead, and is also possible to permit the designation of such a calculation method and coordinate values indicating the arrangement positions as output requirements so that the imposition layout process is carried out according to these designations instead.

In this above embodiment, regarding the finishing method (stitching method, opening direction) when the final resulting matter (image recording media) is a magazine or a book etc., a predetermined method (default value) is used based on the designation of [output=“magazine”]. However, as shown by the fourth and fifth attribute values of FIG. 9, it is also possible for these to be designated as output requirements by the user so as to create a workflow that carries out finishing processing based on this designation. In this case, as with the imposition layout process, this processing is carried out according to the specified finishing method.

In this embodiment, coordinates (Ofs1 to Ofs4) indicating the arrangement positions of each page to be printed simultaneously are calculated for applying of the workflow creation rules and the coordinate values are taken as parameters for the imposition layout process. However, in place of this, it is also possible to take the paper size and page size designated in the output requirements as parameters for the imposition layout process. In this case, in the imposition layout process, pages are arranged in such a manner as to collect pages of the designated size on the paper according to the paper size constituting the output size. For example, as shown in the example in FIG. 13, in the imposition layout process, it is determined that it is possible to arrange four pages provided as attribute values on paper of a size provided as an attribute value, and positions Ofs1 to Ofs4 of the four pages and their orientations are decided upon.

While the invention has been described in detail, the foregoing description is in all aspects illustrative and not restrictive. It is understood that numerous other modifications and variations can be devised without departing from the scope of the invention.

This application claims priority based on Japanese Patent Application No. 2003-170900 entitled “Apparatus and Method for Creating A Workflow for Printing and Prepressing Manufacturing” applied for on Jun. 16, 2003, the contents of which are hereby incorporated by reference.

What is claimed is:

1. An apparatus for generating a workflow for making image recording media recorded with images expressed by page data from the page data described in page description language, comprising:
a designator for designating attributes of the image recording media constituting finally resulting matter resulting due to processing based on the workflow to be created; and
a workflow creator for creating the workflow by deciding upon processes required in order to make the image recording media and parameter values for the required processes based on attributes designated by the designator.

2. The apparatus of claim 1, further comprising a ticket creator for creating a job ticket indicating content of processes required to make the image recording media based on the workflow created by the workflow creator.

3. The apparatus of claim 2, wherein the workflow creator comprises:
a rule storage unit for storing rules, corresponding to each attribute selectable for the image recording media, for creating the workflow for making the image recording media, in advance;
an environmental information storage unit for storing in advance environmental information indicating an environment for executing each process capable of being selected for making the image recording media; and
a process content decider for deciding upon processes required to make the image recording media and parameter values for the required processes based on attributes designated by the designator by referring to the rules and the environmental information.

4. The apparatus of claim 2, further comprising:
a display having a prescribed screen;
a pointing device operated by a user for designating positions of the screen; and
a display controller for displaying a plurality of icons indicating the respective attributes selectable for the image recording media constituting the finally resulting matter at the display,
wherein the designator registers an attribute indicated by a selected icon as an output requirement when one of the plurality of icons is selected due to an operation of the pointing device;
the workflow creator creates a workflow based on attributes registered as output requirements; and
when the workflow creator creates a workflow, the display controller displays the created workflow at the display.

5. The apparatus of claim 4, wherein:
the display controller displays a first area displaying a plurality of icons indicating the respective selectable attributes, a second area displaying icons indicating attributes registered as output requirements, and a third area displaying the created workflow in a distinguishable manner at the screen; and
when one of the icons displayed at the first area is dragged and dropped to the second area by the pointing device, the designator registers the attribute indicated by the dragged and dropped icon as an output requirement.

6. The apparatus of claim 5, wherein:
when one of the icons registered as an output requirement displayed in the second area is double-clicked using the pointing device, the display controller separately displays an operation screen for setting detailed content for the attribute indicated by the double-clicked icon at the display, and
the designator registers detailed content set based on user operations of the separately displayed operation screen as output requirements.

7. The apparatus of claim 4, wherein when one of the plurality of icons indicating the respective selectable attributes is double-clicked by the pointing device, the designator registers the attribute indicated by the double-clicked icon as output requirements.

8. A printing and prepressing manufacturing system comprising the apparatus of claim 1
and further comprising an executor for executing processing on the page data based on the workflow created by the workflow creator so as to make the image recording media with attributes designated by the designator.

9. A printing and prepressing manufacturing system comprising the apparatus of claim 2
and further comprising:
a ticket storage unit for storing tickets generated by the ticket creator, and
an executor for issuing tickets saved at the ticket storage unit when new page data is obtained and executing processing of the content indicated by the issued ticket on the new page data so that the image recording media having attributes designated by the designator is made.

10. A method for generating a workflow for making image recording media recorded with images expressed by page data from the page data described in page description language, comprising the steps of:
designating attributes of the image recording media constituting finally resulting matter resulting due to processing based on the workflow to be created; and
creating the workflow by deciding upon processes required in order to make the image recording media and parameter values for the required processes based on designated attributes.

11. The method of claim 10, further comprising a step of creating a job ticket indicating content of processes required to make the image recording media based on the workflow created in the workflow creating step.

12. The method of claim 11, wherein the workflow creating step comprises the steps of:
reading rules, corresponding to each attribute selectable for the image recording media, for creating the workflow for making the image recording media;
reading environmental information indicating an environment for executing each process capable of being selected for making the image recording media; and
deciding upon processes required to make the image recording media and parameter values for the required processes based on the designated attributes by referring to the rules and the environmental information.

13. A program for generating a workflow for making image recording media recorded with images expressed by page data from the page data described in page description language, the program, when executed by a computer, causing the computer to perform the steps of:
designating attributes of the image recording media constituting finally resulting matter resulting due to processing based on the workflow to be created; and
creating the workflow by deciding upon processes required in order to make the image recording media and parameter values for the required processes based on designated attributes.

14. The program of claim 13, further comprising a step of creating a job ticket indicating content of processes required to make the image recording media based on the workflow created in the workflow creating step.

15. The program of claim 14, wherein the workflow creating step comprises the steps of:
reading rules, corresponding to each attribute selectable for the image recording media, for creating the workflow for making the image recording media;
reading environmental information indicating an environment for executing each process capable of being selected for making the image recording media; and
deciding upon processes required to make the image recording media and parameter values for the required processes based on the designated attributes by referring to the rules and the environmental information.
